(19) United States
(12) Patent Application Publication
(10) Pub. No.: US 2019/0362579 A1
(43) Pub. Date: Nov. 28, 2019

(54) SMART LOCKER SYSTEM

(71) Applicant: PHILLIPS CONNECT TECHNOLOGIES LLC, Santa Fe Springs, CA (US)

(72) Inventor: Robert Alexander Phillips, Laguna Niguel, CA (US)

(21) Appl. No.: 16/419,729

(22) Filed: May 22, 2019

Related U.S. Application Data
(60) Provisional application No. 62/674,749, filed on May 22, 2018.

(51) Int. Cl. G07C 9/00; F25D 23/02

(52) U.S. Cl. CPC G07C 9/00912; F25D 2700/06; F25D 2600/06; F25D 23/028

(57) ABSTRACT

A smart locker system includes a plurality of compartments configured to accommodate different types of packages, a cooling system coupled to one or more of the plurality of compartments, and configured to cool the one or more of the plurality of compartments, and a controller configured to individually control a locked and unlocked state of each of the plurality of compartments, and to control the cooling system.

### CROSS-REFERENCE TO RELATED APPLICATION

This application claims priority to U.S. Application No. 62/674,749, filed on May 22, 2018, the entire content of which is incorporated herein by reference.

### FIELD

The invention relates to a smart locker system and a method of controlling the same.

### BACKGROUND

The online purchase of household goods has seen explosive growth in the past several years. With the recent announcement that Whole Foods Market has been acquired by Amazon, industry analysts predict tremendous changes are in store for traditional grocery chain businesses, which have remained mostly unchanged for more than a century. In fact, more than 80% of Americans have bought products online in the past month, and this trend is continuing to build momentum. Grocery items will likely follow the same trend line, however it will not be without a fairly substantial change in the manner that home delivery takes place.

Along with the rise in confidence of online ordering comes a negative side-effect, namely, a steady rise in theft of delivered products from the doorsteps of homes. This has resulted in staggering growth of front-door camera sales for products like Ring and Nest Cams, which enable homeowners to monitor activities at the front of their homes.

However, there is a critical deficiency in the delivery chain relative to how cold and frozen grocery goods are delivered and received into homes. In order to take advantage of the convenience of home delivery of standard groceries, the purchasing consumer must schedule a window of time to receive the groceries, and hope that schedule changes or late deliveries don't occur. What should be a convenience often becomes a hindrance to consumers, as the delivery method eliminates any flexibility to leave the home during the delivery window.

Certainly, if the online purchase of perishable goods is to continue to expand, a better model is needed to order, deliver, and receive these everyday items.

The information disclosed in this Background section above is only for enhancement of understanding of the background of the invention and therefore it may contain information that does not form the prior art that is already known to a person of ordinary skill in the art.

### SUMMARY

Aspects of embodiments of the invention are directed to a smart multi-compartment, multi-temperature locker system for delivery and safe storage of an assortment of consumer products including perishable goods. In some embodiments, the smart locker system includes a plurality of compartments configured to accommodate different types of consumer goods. According to some embodiments, the smart locker system is capable of controlling the temperature of one or more of its constituent compartments according to the presence and type of the delivered produce.

According to some embodiments of the invention, there is provided a smart locker system including: a plurality of compartments configured to accommodate different types of packages; a cooling system coupled to one or more of the plurality of compartments, and configured to cool the one or more of the plurality of compartments; and a controller configured to individually control a locked and unlocked state of each of the plurality of compartments, and to control the cooling system.

In some embodiments, a first compartment, a second compartment, and a third compartment of the plurality of compartments are a first cooling chamber, a second cooling chamber, and an ambient storage chamber, respectively.

In some embodiments, the cooling system is configured to maintain the first cooling chamber at a lower temperature than the second cooling chamber.

In some embodiments, the third compartment is physically expandable to accommodate different size parcels.

In some embodiments, the cooling system includes one or more cooling lines and one or more control valves coupled to the one or more cooling lines, and is configured to remove heat from one or more compartments of the plurality of compartments by opening and or closing the one or more control valves.

In some embodiments, the plurality of compartments include electric doors, without handles, and the controller is configured to open and lock one or more of the electric doors based on proximity to an authorized user and/or a wireless command received from an external device.

In some embodiments, the smart locker system further includes a keypad communicatively coupled to the controller, and configured to receive an authorized code,

wherein the controller is configured to identify and open a compartment of the plurality of compartments based on the authorized code.

In some embodiments, the smart locker system further includes a solar panel mounted to a surface of the smart locker system and an auxiliary battery, wherein the controller is configured to charge the auxiliary battery using electrical power received from the solar panel.

In some embodiments, each of the plurality of compartments is sealed to prevent or substantially prevent intrusion of moisture and dust and is protected against corrosion.

In some embodiments, the smart locker system is securely affixed to the ground using stainless steel tabs that are screwed or anchored in place.

In some embodiments, the smart locker system is partially or fully underground, and is configured to rise above ground level when a package is to be received.

In some embodiments, the smart locker system further includes a power manager configured to detect circuit overloads and/or excessive heat generation, and to transmit a corresponding fault signal to the controller, wherein, in response to the corresponding fault signal, the controller is configured to alert a user and/or a monitoring server external to the smart locker system of a power fault condition.

In some embodiments, each of the compartments includes one or more sensors including a pressure sensor and/or a temperature sensor.

In some embodiments, the pressure sensor is configured to detects a positive pressure change, when a package is placed in a corresponding compartment, to detects a negative pressure change, when the package is removed from the corresponding compartment, and to report the detected positive or negative pressure change to the controller, and the controller is configured to determine that an object has been placed in the corresponding compartment when the detected positive pressure change exceeds a first threshold, and to determine that the object has been removed from the corresponding compartment when the detected negative pressure change is below a second threshold.

In some embodiments, the corresponding compartment is a cooling chamber, and the controller is further configured to signal the cooling system to cool the cooling chamber down to a temperature, when the package is placed in the corresponding compartment, and to signal the cooling chamber to stop cooling the corresponding compartment to conserve energy, when the package is removed from the corresponding compartment.

In some embodiments, the temperature sensor is configured to measure an internal temperature of the corresponding compartment, and

wherein the controller is configured to regulate the internal temperature based on the measurement of the temperature sensor.

In some embodiments, the smart locker system further includes a transceiver configured to communicatively couple the controller to a remote server, wherein, when the controller receives a signal from the remote server indicating that an order for a refrigerated item has been placed, the controller is configured to signal the cooling system to cool a corresponding compartment to a desired temperature prior to an expected delivery date.

In some embodiments, the controller is configured to alert a user device of a status of each of the compartments or the smart locker system, via a transceiver communicatively coupled to the user device, and the status includes a shipment has been received and an inability to maintain critical temperature at a compartment of the plurality of compartments.

### BRIEF DESCRIPTION OF THE DRAWINGS

In order to facilitate a fuller understanding of the invention, reference is now made to the accompanying drawings, in which like elements are referenced with like numerals. These drawings should not be construed as limiting the invention, but are intended to be illustrative only.

FIG. 1 illustrates a smart locker system, according to some exemplary embodiments of the invention.

FIG. 2 is a block diagram illustrating the components of the smart locker system, according to some embodiments of the invention.

### DETAILED DESCRIPTION

The detailed description set forth below in connection with the appended drawings is intended as a description of illustrative embodiments of a smart locker system in accordance with the present invention, and is not intended to represent the only forms in which the present invention may be implemented or utilized. The description sets forth the features of the present invention in connection with the illustrated embodiments. It is to be understood, however, that the same or equivalent functions and structures may be accomplished by different embodiments that are also intended to be encompassed within the spirit and scope of the present invention. As denoted elsewhere herein, like element numbers are intended to indicate like elements or features.

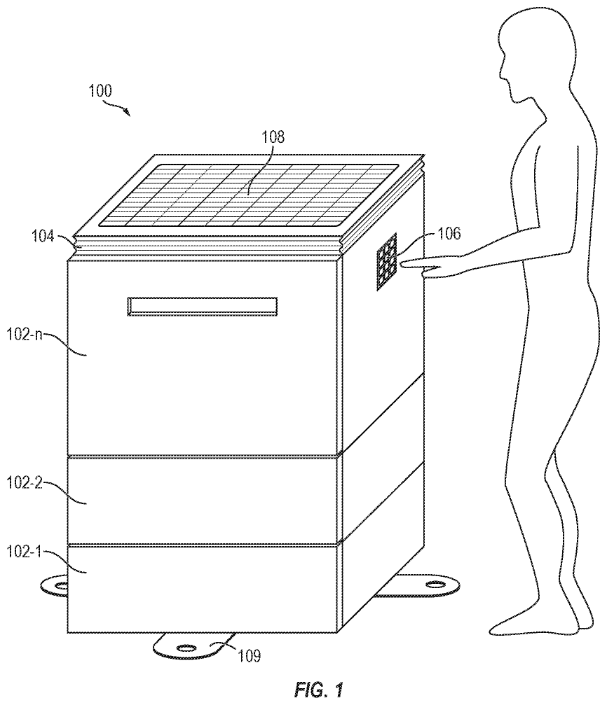

FIG. 1 illustrates a perspective view of the smart locker system 100, according to some exemplary embodiments of the invention.

Referring to FIG. 1, according to some embodiments, the smart locker system 100 includes a plurality of compartments 102-1 to 102-n (where n is an integer greater than 1), each of which may accommodate a different type and/or size of product/package. For example, the first compartment 102-1, which may be lowermost compartment, may operate as a first cooling chamber (e.g., a freezer) capable of storing frozen goods for a period of time; the second compartment 102-2 may operate as a second cooling chamber (e.g., a refrigerator) capable of storing perishable goods (e.g., fresh produce) for a period of time; and the third compartment 102-3, which may be the topmost compartment, may operate as an ambient storage chamber for storing regular mail items and packages, or foods that do not require refrigeration. In some embodiments, the third compartment 102-3 may be physically expandable to accommodate different size parcels. For example, the top of the third compartment 102-3 may include an expandable portion (in the form of, e.g., an accordion expander) 104 that may allow the third compartment 102-3 to expand vertically, as desired.

In some embodiments, the compartments 102-1 to 102-n may have electric doors, without handles, that open and close/lock based on proximity to an authorized user (e.g., a home owner or an authorized delivery person) and/or based on wireless commands received from an external device (e.g., a smart phone, tablet, or laptop). In some embodiments, the smart locker system 100 has a keypad 106 that acts as a backup entry device, which opens one or more of the compartments 102-1 to 102n when an authorized code is entered. In some examples, each package may have its own code (e.g., a temporary or one-time code), which, when entered, allows the smart locker system 100 to identify the appropriate compartment 102 to open. For example, a package containing perishable goods may include a code that, when entered, opens the first or second compartments 102-1 and 102-2.

As will be recognized by a person of ordinary skill, the authentication functionality of the keypad 106 may be replaced by, or supplemented by, an iris scanner, a fingerprint reader, and/or any other suitable authentication mechanism.

In some embodiments, solar panels 108 that are mounted on one or more surfaces (e.g., the top surface) of the smart locker system 100 provide electrical power to the system. For example, the solar panels 108 may charge a backup/auxiliary battery within the smart locker system 100.

According to some embodiments, to protect delivered packages from the elements, each of the compartments 102-1 to 102-n may be sealed or otherwise configured to prevent or substantially prevent intrusion of moisture and dust and is protected against corrosion. For example, the compartments 102 may be IP69K-rated.

As shown in FIG. 1, the smart locker system 100 may be a column placed above ground. In some embodiments, the smart locker system 100 may be permanently and securely affixed to the ground using stainless steel tabs 109 that may be screwed or otherwise anchored in place. However, embodiments of the invention are not limited to the illustrated configuration. For example, the smart locker system 100 may be partially or fully hidden underground, and may rise above ground level when a package is to be received at, or retrieved from, the smart locker system 100. Further, the column may be rectangular, as shown, or may have any suitable shape (e.g., may have a curved cross-sectional profile).

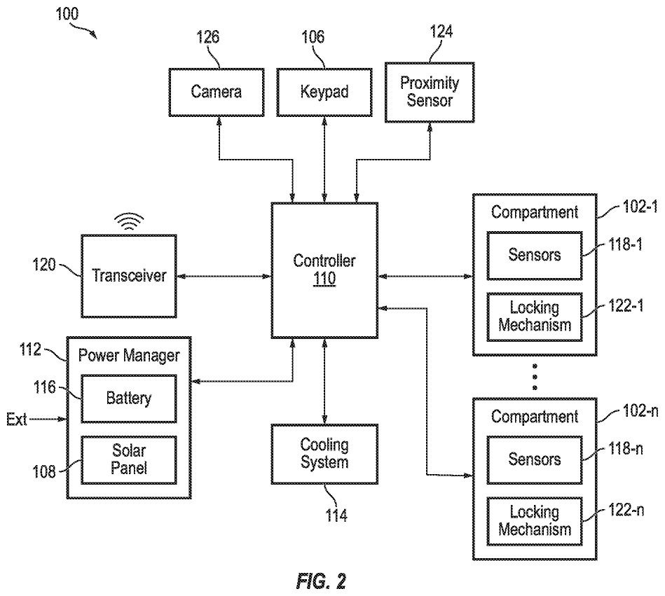

FIG. 2 is a block diagram illustrating the components of the smart locker system 100, according to some embodiments of the invention.

Referring to FIG. 2, in some embodiments, the smart locker system 100 further includes a controller 110 for electrically monitoring and controlling each of the components of the smart locker system 100, a power manager 112 for powering the smart locker system 100, and a cooling system 114 for cooling one or more of the compartments 102-1 to 102-n.

The power manager 112 may receive electrical power from an external source EXT, such as a power line (e.g., a 110 V DC line) connected to the electrical grid of a home, outside of which the smart locker system 100 may be installed. The power manager 112 may have a battery 116 that acts as a backup or auxiliary source of power for the smart locker system 100, when the power received from the external source EXT is either insufficient or not present. However, embodiments of the invention are not limited thereto, and the battery 116 may operate as the primary source of power to the smart locker system 100 and the external source EXT may serve to recharge the battery 116. In some examples, the smart locker system 100 may receive power from solar panels 108 that may be installed on the top and/or side panel(s) of the smart locker system 100. The solar panels 108 may be used to charge the battery 116 during daytime. The power manager 112 may be capable of self-diagnosis (under the direction of the controller 110) to detect any circuit overloads and/or excessive heat generation. If such conditions are detected, the power manager 112 may transmit a corresponding fault signal to the controller 110, which may in turn alert a user (e.g., the homeowner) and/or a monitoring server external to the smart locker system 100 that a power fault condition has occurred.

In some embodiments, the cooling system 114 removes heat from the one or more compartments 102 via one or more cooling lines and control valves, which may be opened or closed based on control signals received from the controller 110 or the cooling system 114 itself. The cooling system 114 may be a traditional refrigeration system having a compressor, a heat exchanger (e.g., a condenser), an expansion valve, and an evaporator (e.g., and evaporation coil), or may be any other suitable cooling system 114, such as one relying on geothermal cooling.

According to some embodiments, each of the compartments 102-1 to 102-n includes one or more sensors 118, which may include a weight sensor (e.g., a pressure sensor), a temperature sensor, and/or the like. For example, when a package is placed in a compartment 102, the weight sensor detects a positive pressure change and reports it to the controller 110. If the positive pressure change is above a preset threshold, the controller 110 determines that an object has been placed in the corresponding compartment 102. Upon such determination, if the compartment is a cooling chamber (e.g., is 102-1 or 102-2), the controller may signal the cooling system 114 to cool the chamber down to the appropriate temperature. The temperature reading from the temperature sensor inside the cooling chamber may be used to regulate the chamber's temperature. Similarly, when a package is removed from a compartment 102, the weight sensor detects a negative pressure change and reports it to the controller 110. If the negative pressure change is below a preset threshold, the controller 110 determines that an object has been removed from the corresponding compartment 102. Upon such determination, if the compartment is a cooling chamber (e.g., is 102-1 or 102-2), the controller 110 may signal the cooling system 114 to stop cooling the chamber, in order to conserve energy.

In some embodiments, the smart locker system 100 includes a transceiver 120 to enable internet connectivity. The transceiver 120 may include a hard-wired cable transceiver, a wireless transceiver (e.g., to connect via WiFi), and/or an onboard cellular chip to ensure constant connectivity to the internet. When an order for a product is placed online and a delivery schedule is set, an online server may communicate the expected delivery period to the smart locker system 100. If the delivery is for a frozen or refrigerated item, the controller 110 may prompt the cooling system 114 to cool the corresponding compartment(s) (e.g., 102-1 and/or 102-2) to a suitable temperature in advance of scheduled delivery. Once the package is removed from the corresponding compartment(s), the controller 110 may prompt the cooling system to stop cooling the compartment(s). This ensures that the delivered perishable good is maintained at the proper temperature at all times, while also conserving energy when the cooling chambers are not in use.

According to some embodiments, each compartment 102 includes an electronic locking mechanism 122 that allows the controller 110 to control the opened/closed/locked state of the compartment 102. For example, the controller 110 may unlock the locking mechanism(s) 122 in response to a command received from a user's smart device (e.g., a smart phone) that may be connected to the smart locking device via an application (or an “app”), or may automatically unlock the appropriate compartment(s) in response to detection of a connected device within a proximate range (e.g., within about 3 feet or about 6 feet) of the smart locker system 100. Thus, when the controller 110 determines that an owner of the locker system 100 or an authorized delivery person, who carries the connected device, is approaching the smart locker system 100, the controller 110 automatically opens the appropriate compartment 102 to allow for delivery or collection of a package. The controller 110 may control the locking mechanisms 122-1 to 122-n to maintain the compartments 102-1 to 102-n in a locked state at all other times. Proximity detection may be facilitated by a proximity sensor 124 that may installed on a panel or a compartment door of the smart locker system 100.

The smart locker system 100 may be capable of providing automatic notifications to the owner via a connected application installed on the smart device of the owner (which may, e.g., be an Android or iOS device). For example, the smart locker system 100 may alert the user when a shipment has been received, and/or when there is inadequate power (e.g., inadequate charge at the battery 116) to maintain critical temperatures in the compartments 102. Further, the application installed on the user device may allow the user to monitor the power utilization of the smart locker system 100, to view shipment time forecasts, and be alerted of delayed shipments and failed delivery attempts due to the package size exceeding the available storage space.

In some examples, the smart locker system 100 may have available to it, a host of security features, such as internal infrared motion detection sensors, external lighting to assist with evening deliveries, a one-touch “panic” button, which sounds an audible alarm, and a camera 126 to capture a photo or a video segment every time one of the compartments 102 is opened. The captures images/videos may be stored locally and/or on a remote server (e.g., a cloud server), and may be downloadable/viewable on the smart device of the user.

Accordingly, by utilizing a combination of several different emerging technologies, including internet of things (IoT), cloud-computing, order scheduling, monitoring, and delivery tracking, as well as product-level technologies like precision smart-scales and a plethora of sensors, online ordering can pave the way for a new type of connected mailbox, which will in time replace what we have used to collect and send mail since the dawn of industrialization.

The present invention is not to be limited in scope by the specific embodiments described herein. Indeed, other various embodiments of and modifications to the invention, in addition to those described herein, may be apparent to those of ordinary skill in the art from the foregoing description and accompanying drawings. Thus, such other embodiments and modifications are intended to fall within the scope of the invention. Further, although the invention has been described herein in the context of a particular implementation in a particular environment for a particular purpose, those of ordinary skill in the art may recognize that its usefulness is not limited thereto and that the invention may be beneficially implemented in any number of environments for any number of purposes. Accordingly, the claims set forth below should be construed in view of the full breadth and spirit of the invention as described herein and equivalents thereof.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

The smart locker system and/or any other relevant devices or components according to embodiments of the invention described herein may be implemented utilizing any suitable hardware, firmware (e.g., an application-specific integrated circuit), software, or a suitable combination of software, firmware, and hardware. For example, the various components of the smart trailer may be formed on one integrated circuit (IC) chip or on separate IC chips. Further, the various components of the smart trailer may be implemented on a flexible printed circuit film, a tape carrier package (TCP), a printed circuit board (PCB), or formed on a same substrate. Further, the various components of the smart trailer may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

What is claimed is:

1. A smart locker system comprising:
a plurality of compartments configured to accommodate different types of packages;
a cooling system coupled to one or more of the plurality of compartments, and configured to cool the one or more of the plurality of compartments; and
a controller configured to individually control a locked and unlocked state of each of the plurality of compartments, and to control the cooling system.

2. The smart locker system of claim 1, wherein a first compartment, a second compartment, and a third compartment of the plurality of compartments are a first cooling chamber, a second cooling chamber, and an ambient storage chamber, respectively.

3. The smart locker system of claim 2, wherein the cooling system is configured to maintain the first cooling chamber at a lower temperature than the second cooling chamber.

4. The smart locker system of claim 2, wherein the third compartment is physically expandable to accommodate different size parcels.

5. The smart locker system of claim 1, wherein the cooling system comprises one or more cooling lines and one or more control valves coupled to the one or more cooling lines, and is configured to remove heat from one or more compartments of the plurality of compartments by opening and or closing the one or more control valves.

6. The smart locker system of claim 1, wherein the plurality of compartments comprise electric doors, without handles, and
wherein the controller is configured to open and lock one or more of the electric doors based on proximity to an authorized user and/or a wireless command received from an external device.

7. The smart locker system of claim 1, further comprising a keypad communicatively coupled to the controller, and configured to receive an authorized code,
wherein the controller is configured to identify and open a compartment of the plurality of compartments based on the authorized code.

8. The smart locker system of claim 1, further comprising a solar panel mounted to a surface of the smart locker system and an auxiliary battery,
wherein the controller is configured to charge the auxiliary battery using electrical power received from the solar panel.

9. The smart locker system of claim 1, wherein each of the plurality of compartments is sealed to prevent or substantially prevent intrusion of moisture and dust and is protected against corrosion.

10. The smart locker system of claim 1, wherein the smart locker system is securely affixed to the ground using stainless steel tabs that are screwed or anchored in place.

11. The smart locker system of claim 1, wherein the smart locker system is partially or fully underground, and is configured to rise above ground level when a package is to be received.

12. The smart locker system of claim 1, further comprising a power manager configured to detect circuit overloads and/or excessive heat generation, and to transmit a corresponding fault signal to the controller,
wherein, in response to the corresponding fault signal, the controller is configured to alert a user and/or a monitoring server external to the smart locker system of a power fault condition.

13. The smart locker system of claim 1, wherein each of the compartments comprises one or more sensors comprising a pressure sensor and/or a temperature sensor.

14. The smart locker system of claim 13, wherein the pressure sensor is configured to detects a positive pressure change, when a package is placed in a corresponding compartment, to detects a negative pressure change, when the package is removed from the corresponding compartment, and to report the detected positive or negative pressure change to the controller, and
wherein the controller is configured to determine that an object has been placed in the corresponding compartment when the detected positive pressure change exceeds a first threshold, and to determine that the object has been removed from the corresponding compartment when the detected negative pressure change is below a second threshold.

15. The smart locker system of claim 14, wherein the corresponding compartment is a cooling chamber, and
wherein the controller is further configured to signal the cooling system to cool the cooling chamber down to a temperature, when the package is placed in the corresponding compartment, and to signal the cooling chamber to stop cooling the corresponding compartment to conserve energy, when the package is removed from the corresponding compartment.

16. The smart locker system of claim 15, wherein the temperature sensor is configured to measure an internal temperature of the corresponding compartment, and
wherein the controller is configured to regulate the internal temperature based on the measurement of the temperature sensor.

17. The smart locker system of claim 1, further comprising a transceiver configured to communicatively couple the controller to a remote server,
wherein, when the controller receives a signal from the remote server indicating that an order for a refrigerated item has been placed, the controller is configured to signal the cooling system to cool a corresponding compartment to a desired temperature prior to an expected delivery date.

18. The smart locker system of claim 1, wherein the controller is configured to alert a user device of a status of each of the compartments or the smart locker system, via a transceiver communicatively coupled to the user device, and
wherein the status comprises a shipment has been received and an inability to maintain critical temperature at a compartment of the plurality of compartments.
